(19) United States
(12) Patent Application Publication
(10) Pub. No.: US 2012/0156516 A1
(43) Pub. Date: Jun. 21, 2012

(54) THREE-DIMENSIONAL MODELING DEVICE, THREE-DIMENSIONAL MODELING METHOD, AND MODEL FORMED BY THE METHOD

(75) Inventors: Takeshi Matsui, Tokyo (JP); Junichi Kuzusako, Saitama (JP); Nobuhiro Kihara, Kanagawa (JP); Hiroyuki Yasukochi, Kanagawa (JP); Kazuo Niizaka, Tokyo (JP)

(73) Assignee: SONY CORPORATION, Tokyo (JP)

(21) Appl. No.: 13/325,220

(22) Filed: Dec. 14, 2011

(30) Foreign Application Priority Data
Dec. 21, 2010 (JP) 2010-284440

(51) Int. Cl. B32B 27/08; B05D 1/34; B32B 19/00; B05C 5/02

(52) U.S. Cl. 428/515; 118/695; 427/196; 428/688

(57) ABSTRACT

A three-dimensional modeling device, including: a stage having a powder material deposited thereon for lamination; a supply mechanism supplying the powder material for each one layer on the stage; a plurality of heads having a plurality of nozzles ejecting a liquid for formation of a model, respectively, and capable of ejecting the liquid to the powder material supplied onto the stage by the supply mechanism; and a moving mechanism moving the plurality of heads in different directions relative to the stage, respectively.

### BACKGROUND

The present disclosure relates to a three-dimensional modeling device and a three-dimensional modeling method that form a model in a three-dimensional shape by lamination based on cross-sectional image data, and a model formed by the method.

In the past, a three-dimensional modeling device of this type is recognized as a device called as rapid prototyping, and is widely used for industrial applications. As major systems for three-dimensional modeling devices, there are an optical modeling system, a sheet lamination modeling system, and a powder modeling system.

The optical modeling system is to form a cross-sectional shape by irradiating a photocurable resin with a high power laser and to laminate it, thereby creating a three-dimensional shape. The sheet lamination modeling system is to cut out thin sheets in layers and adhere and laminate them to create a three-dimensional shape. The powder modeling system is to spread a powder material in layers and to make a cross-sectional shape and then to laminate them to create a three-dimensional shape.

The powder modeling system is further classified roughly into those melting or sintering powder and those solidifying powder using an adherent. The latter ejects a liquid, such as an adherent and a binder, to powder containing gypsum as a main component using an ink jet head used for a printer or the like for solidification and forms a cross-sectional layer and laminates them, thereby creating a three-dimensional shape.

In powder modeling utilizing an ink jet head, using a head of a commercially available ink jet printer, for example, a liquid, such as an adherent, is selectively ejected on a sheet with powder spread thereon in accordance with a region to solidify the powder just like printing. The three-dimensional modeling device described in Japanese Unexamined Patent Application Publication No. 2009-101651 is a device employing an ink jet head of a powder modeling system (refer to Japanese Unexamined Patent Application Publication No. 2009-101651, for example).

### SUMMARY

In a modeling device using an ink jet head of a powder modeling system, in a case of occurring an ejection defect, such as clogging, in a part of a plurality of nozzles included in the ink jet head, for example, a powder layer including the defect area is laminated. That is, since an ink jet head is scanned in a predetermined direction, a severe problem arises that a linear unbound area is developed in a model formed in a case of occurring an ejection defect in an ejection unit and the model is easily broken in one direction.

It is desirable to provide a three-dimensional modeling device and a three-dimensional modeling method that can inhibit formation of a region to make a model easily broken out of regions composing the model and can prevent the model from being damaged in the easily breaking directions, and a model formed by the method.

A three-dimensional modeling device according to an embodiment of the present disclosure includes a stage, a supply mechanism, a plurality of heads, and a moving mechanism.

On the stage, a powder material is deposited for lamination.

The supply mechanism supplies the powder material for each one layer on the stage.

The plurality of heads has a plurality of nozzles ejecting a liquid for formation of a model, respectively, and is capable of ejecting the liquid to the powder material supplied onto the stage by the supply mechanism.

The moving mechanism moves the plurality of heads in different directions relative to the stage, respectively.

Even in a case an ejection defect is developed in one of the plurality of nozzles in at least one head, the plurality of heads is moved in different directions relative to the stage by the moving mechanism. That is, according to an embodiment of the present disclosure, it is possible to inhibit the formation of a defect region, which is a boundary region making a model easily broken and focused in one direction, possibly occurring in a case that only one head is provided. Accordingly, it is possible to prevent a model from being damaged in the easily breaking directions.

The moving mechanism may also move two heads, which are the plurality of heads, to make moving directions of the two heads to be orthogonal. The directions of moving the two heads are orthogonal, thereby being possible to simplify the structure of the head and the moving mechanism in comparison to a case of not being orthogonal.

The moving mechanism may also alternately move the plurality of heads every time the powder material for one layer is supplied by the supply mechanism. Thus, in a case that an ejection defect is developed, it is possible to inhibit the formation of a defect region continuously at a same position in the direction of laminating the powder material. Alternatively, it may also be as the following embodiment.

The moving mechanism may also move a first head out of the plurality of heads when the powder material for a continuous first number of layers is supplied by the supply mechanism, and may also move a second head, different from the first head, out of the plurality of heads when the powder material for a continuous second number of layers is supplied by the supply mechanism.

In this case, the first number of layers may also be different from the second number of layers. For example, the embodiment of the present disclosure is useful in a case that a liquid ejected from each head is different respectively and in a case that a material supplied by the supply mechanism is respectively different for each head.

The supply mechanism may also supply a plurality of different powder materials corresponding to the plurality of heads, respectively, to the stage. Alternatively, as described above, the plurality of heads may also eject different liquids, respectively. These embodiments of the present disclosure enable to form a model having different properties for each one or plurality of layers composing the model.

A three-dimensional modeling device according to another embodiment of the present disclosure includes a stage, a supply mechanism, a head, and a moving mechanism.

On the stage, a powder material is deposited for lamination.

The supply mechanism supplies the powder material for each one layer on the stage.

The head has a plurality of nozzles ejecting a liquid for formation of a model and is capable of ejecting the liquid to the powder material supplied onto the stage by the supply mechanism.

The moving mechanism moves the head in respective different directions relative to the stage when the liquid is ejected respectively to the powder material for different layers supplied by the supply mechanism.

Even in a case an ejection defect is developed in one of the plurality of nozzles included in the head, the head is moved in different directions relative to the stage by the moving mechanism. That is, it is possible to inhibit the formation of a defect region, which is a boundary region making a model easily broken and focused in one direction, possibly occurring in a case that only one head is provided, and it is possible to prevent a model from being damaged.

In this case, the three-dimensional modeling device may also further include a rotation mechanism rotating the head about an axis along a direction of laminating the powder material. Thus, a direction of moving the head can be changed.

A three-dimensional modeling method according to an embodiment of the present disclosure includes supplying a powder material for one layer onto a stage.

A liquid for formation of a model is ejected, while moving a first head in a first direction relative to the stage, from the first head to the powder material supplied onto the stage.

The powder material for another layer is supplied onto the stage after ejecting the liquid from the first head.

A liquid for formation of a model is ejected, while moving a second head in a second direction, different from the first direction, relative to the stage, from the second head to the powder material supplied onto the stage.

A model according to an embodiment of the present disclosure is a model formed by the three-dimensional modeling method described above.

As described above, according to the embodiments of the present disclosure, it is possible to inhibit formation of a region to make a model easily broken out of regions composing the model and to prevent the model from being damaged in the easily breaking directions.

### BRIEF DESCRIPTION OF THE DRAWINGS

FIG. 1 illustrates a three-dimensional modeling device according to an embodiment of the present disclosure;

FIG. 2 is a perspective view illustrating an internal structure of a main box of a three-dimensional modeling device;

FIG. 3 is a plan view of the three-dimensional modeling device illustrated in FIG. 2;

FIG. 4 is a cross-sectional view of the three-dimensional modeling device taken from a side face and illustrates a state of the three-dimensional modeling device in which a top cover is removed from the main box;

FIG. 5A is a diagrammatic plan view illustrating an X head and a Y head, and FIG. 5B is a modification thereof;

FIGS. 6A through 6E illustrate a behavior of a three-dimensional modeling device, and are diagrammatic plan views of a main portion of the three-dimensional modeling device illustrating the behavior in order;

FIGS. 7A and 7B are plan views illustrating a modeling box housing a model therein that is formed by a method subjected to comparison with the embodiment;

FIG. 8 is a perspective view illustrating a main portion of a three-dimensional modeling device according to another embodiment of the present disclosure;

FIG. 9 is a perspective view illustrating the three-dimensional modeling device illustrated in FIG. 8 in a state in which a top plate and a printing base plate are removed;

FIG. 10 illustrates a main portion of a three-dimensional modeling device according to still another embodiment of the present disclosure and is a plan view illustrating a modeling box and heads; and

FIG. 11 illustrates a main portion of a three-dimensional modeling device according to yet another embodiment of the present disclosure and is a plan view illustrating a modeling box and a head.

### DETAILED DESCRIPTION OF EMBODIMENTS

With reference to the drawings, a description is given below to embodiments of the present disclosure.

### Embodiment

### (Configuration of Three-Dimensional Modeling Device)

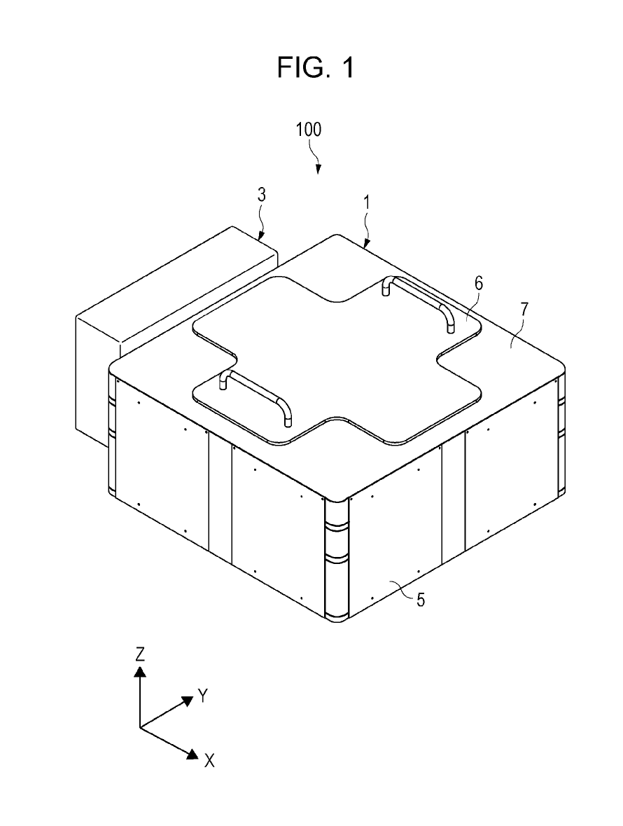

FIG. 1 illustrates a three-dimensional modeling device according to an embodiment of the present disclosure.

A three-dimensional modeling device 100 is provided with a main box 1 approximately in a rectangular parallelepiped shape and a control circuit box 3 connected to the main box 1. The main box 1 has a side cover 5, a main cover 7 mounted on this, and a top cover 6 removable from the main cover 7.

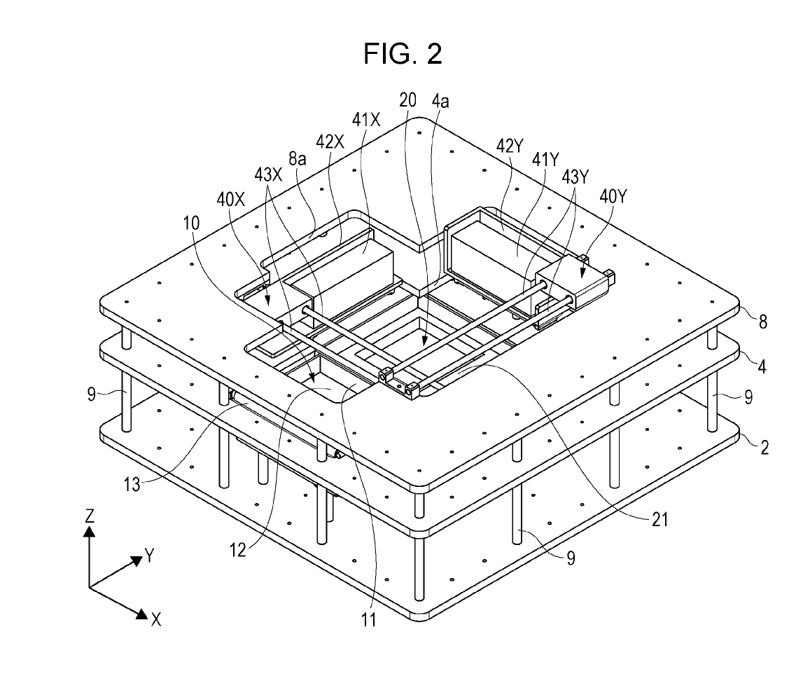

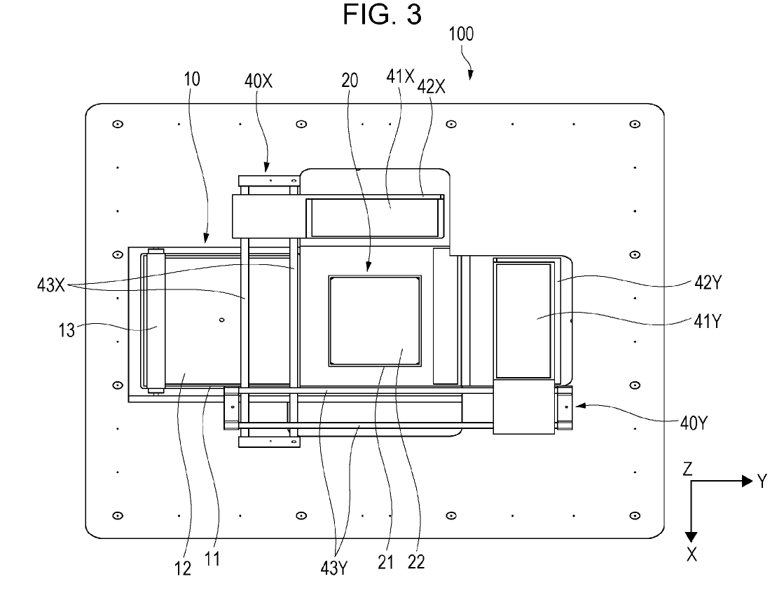

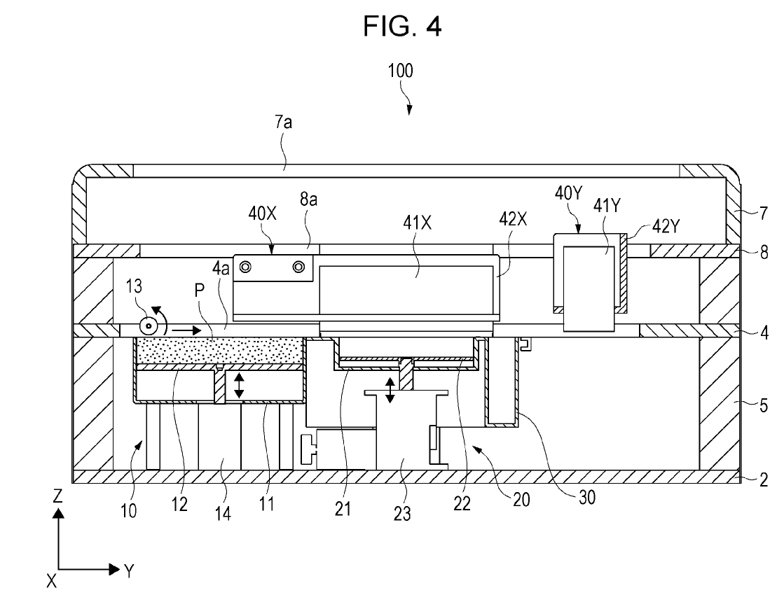

FIG. 2 is a perspective view illustrating an internal structure of a main box 1 of a three-dimensional modeling device 100. FIG. 3 is a plan view of the three-dimensional modeling device 100 illustrated in FIG. 2. FIG. 4 is a cross-sectional view of the three-dimensional modeling device 100 taken from a side face and illustrates a state of the three-dimensional modeling device 100 in which a top cover 6 is removed from the main box 1.

The three-dimensional modeling device 100 has, in order from the bottom, a base plate 2, a printing base plate 4, and a top plate 8, and they are connected by a plurality of column members 9. As illustrated in FIGS. 3 and 4, between the base plate 2 and the printing base plate 4, a supply unit 10 and a modeling unit 20 are provided that are aligned along the Y axis direction. The modeling unit 20 is disposed at a substantially central position in the X and Y axis directions.

The supply unit 10 functioning as a supply mechanism supplies a powder material P (hereinafter, simply referred to as powder P) (refer to FIG. 4) to the modeling unit 20. The supply unit 10 has a supply box 11 retaining the powder P therein, a lifting plate 12 disposed in the supply box 11, and a supply roller 13 provided movably along the Y axis directions in the vicinity of the top faces from a starting end of the supply box 11 over a terminating end of a modeling box 21 described later. The supply roller 13 is movable in the Y axis directions by a moving mechanism not shown, such as a ball screw, for example.

As illustrated in FIGS. 2 and 4, the printing base plate 4, the top plate 8, and the main cover 7 have openings 4a, 8a, and 7a respectively at approximately same positions when viewed in the Z axis direction. On the opening 7a of the main cover 7, the top cover 6 (refer to FIG. 1) is mounted. In a state in which the top cover 6 is removed from the main cover 7, a user supplies the powder P on the lifting plate 12 in the supply box 11 via the openings 4a, 8a, and 7a from above the top plate 8.

The lifting plate 12 can be lifted by a lifting motor 14. The supply roller 13 is movable from, for example, a standby position as illustrated in FIG. 4 in the right direction while rotating (on its axis) counterclockwise. Thus the supply roller 13 moves in the right direction while rubbing on a surface of the powder P deposited on the lifting plate 12, thereby pressing the powder P forward to the modeling unit 20 and supplying the powder P in an amount for one layer to the modeling unit 20.

The modeling unit 20 has the modeling box 21, a modeling stage 22 disposed in the modeling box 21 and letting the powder P to be deposited for lamination, and a lifting motor 23 making the modeling stage 22 to move up and down in the modeling box 21. The powder P supplied by the supply roller 13 as described above is deposited in the modeling box 21 (on the modeling stage 22). When processing a model, every time the powder P in an amount for one layer is supplied by the supply roller 13, the modeling stage 22 is driven by the lifting motor 23 to be lowered for the thickness of the powder P for one layer.

In the modeling unit 20, on the side in the Y axis direction opposite from the side on which the supply unit 10 is provided, a housing box 30 is disposed to house excessive powder P. The excessive powder P is discarded or reused.

On the printing base plate 4, as a plurality of heads respectively ejecting a liquid to the powder P on the modeling stage 22 in the modeling box 21, two heads of an X head 41X and a Y head 41Y are provided. The X head 41X and the Y head 41Y are movable on the modeling box 21 along directions orthogonal to each other.

For example, as illustrated in FIGS. 2 and 3, the X head 41X is movable along the X axis directions by an X axis moving mechanism 40X. The Y head 41Y is movable along the Y axis directions by a Y axis moving mechanism 40Y. The X axis moving mechanism 40X has a guide rail 43X provided along the X axis direction and a head holder 42X holding the X head 41X and provided along the guide rail 43X movably by a motor, not shown. The Y axis moving mechanism 40Y, similar to the X axis moving mechanism 40X, also has a guide rail 43Y provided along the Y axis direction and a head holder 42Y holding the Y head 41Y and provided along the guide rail 43Y movably by a motor, not shown. The X axis moving mechanism 40X and the Y axis moving mechanism 40Y configure a moving mechanism due to a mechanism, such as a ball screw or rack and pinion, for example.

Home positions of the two heads 41X and 41Y, while the three-dimensional modeling device 100 is in a standby state as illustrated in FIG. 3 or the like, are above side portions of the modeling box 21.

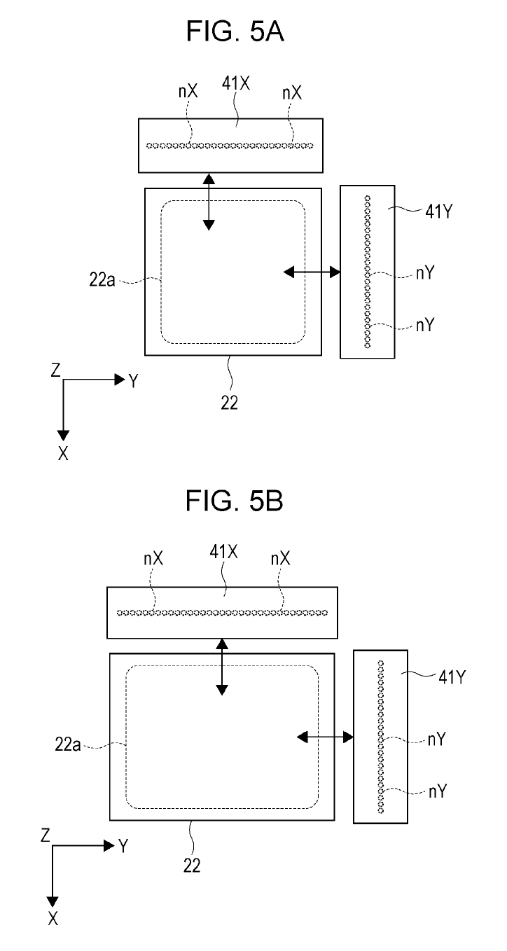

FIG. 5A is a diagrammatic plan view illustrating an X head 41X and a Y head 41Y. The principle of ejecting a liquid by the X head 41X and the Y head 41Y is typically similar to a head of an ink jet printer in the past. The X head 41X and the Y head 41Y are a head of a line shape, respectively. That is, as illustrated in FIG. 3, the length of the X head 41X in the Y axis direction is not less than a length of at least a predetermined modeling region in the modeling box 21 along the Y axis direction.

As illustrated in FIG. 5A, the X head 41X has a plurality of nozzles nX aligned in the Y axis direction to eject a liquid. The length of the Y head 41Y in the X axis direction is not less than a length of the predetermined modeling region 22a in the modeling box 21 along the X axis direction. The Y head 41Y has a plurality of nozzles nY aligned in the X axis direction to eject a liquid. The nozzles nX and nY are provided from 3000 to 5000, for example, in one head.

As illustrated in FIG. 5B, the modeling stage 22 and the modeling region 22a may also be in a rectangular shape viewed in the Z axis direction. In this case, the respective lengths of the X head 41X and the Y head 41Y are also formed in the lengths in accordance with each side of the modeling region 22a.

As the powder P, gypsum is used, for example. In addition, water soluble inorganic substances are used, such as common salt, magnesium sulfate, magnesium chloride, potassium chloride, and sodium chloride, for example. A mixture of sodium chloride and a brine component (such as magnesium sulfate, magnesium chloride, and potassium chloride) may also be used. That is, the powder P contains sodium chloride as a main component. Alternatively, organic substances can also be used, such as polyvinyl pyrrolidone (PVP), polyvinyl alcohol, carboxymethylcellulose, ammonium polyacrylate, sodium polyacrylate, ammonium methacrylate, sodium methacrylate, and a copolymer thereof. The powder P typically has an average particle diameter of not less than 10 μm and not more than 100 μm.

The liquid ejected from the X head 41X and the Y head 41Y includes a component to adhere or bond the powder P with each other in order to form a model. Alternatively, in a case that the powder P includes a binder (for example, an adherent, such as PVP described above) in advance, a liquid to solve the binder, such as water, is used for the liquid.

In a case of coloring the exterior of a model or inside the model, respective dye or pigment inks of cyan, magenta, yellow, and black are used as the liquid. In a case of not coloring, an invisible ink may also be used.

The respective positions of disposing the X axis moving mechanism 40X and the Y axis moving mechanism 40Y in the Z axis direction are on the basis of the position of the top plate 8 in the Z axis direction to avoid mechanical interference to each other. For example, the guide rail 43X of the X axis moving mechanism 40X is disposed at a position in a predetermined distance from the top face of the top plate 8 in the Z axis direction. The guide rail 43Y of the Y axis moving mechanism 40Y is disposed at a position in a predetermined distance from the bottom face of the top plate 8 in the Z axis direction.

In the control circuit box 3 illustrated in FIG. 1, a control circuit, not shown, is built. Although not shown, this control circuit includes controllers including drivers for the motors of each unit and moving mechanism described above, a main controller overall controlling these controllers, and the like. The main controller may also be disposed outside the control circuit box 3. These controllers are composed of hardware, or hardware and software (that is, a computer). The main controller controls each unit and moving mechanism based on laminated cross-sectional image data stored in a memory or the like and composing a modeling object so as to form a model by supplying the powder P for one layer per one item of the image data.

### (Behavior of Three-Dimensional Modeling Device)

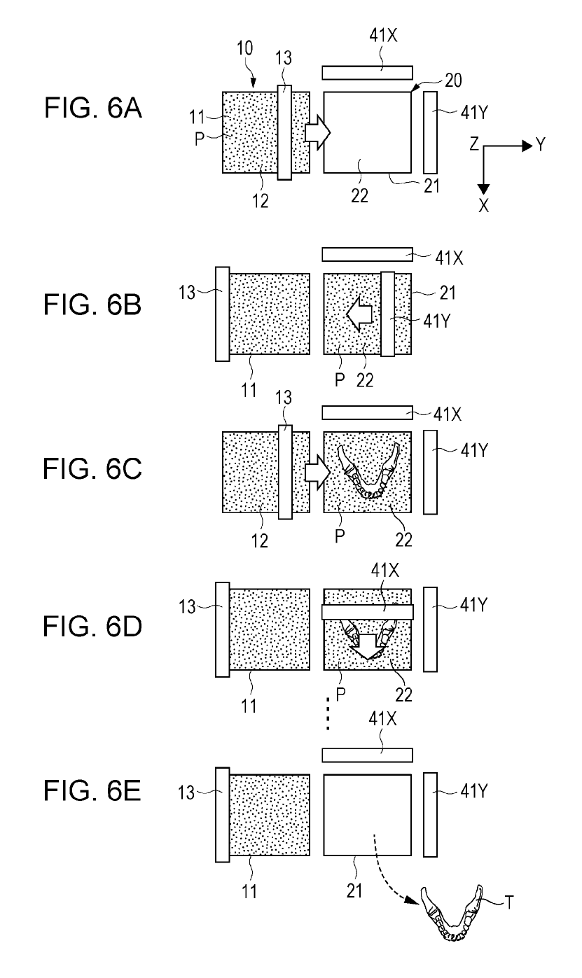

A description is given to a behavior of the three-dimensional modeling device 100 configured as above. FIGS. 6A through 6E are diagrammatic plan views of a main portion of the three-dimensional modeling device 100 illustrating the behavior in order.

Firstly, the modeling stage 22 in the modeling box 21 is disposed at a highest position while modeling in the Z axis direction, and as a modeling process is started, it is lowered along the Z axis direction in a distance for one layer of the powder P, for example. Although the distance for one layer of the powder P is, for example, 0.1 mm, the distance is not limited to this.

The powder P is supplied into the supply box 11. The lifting plate 12 is lifted in a distance possible to supply the powder P, for at least one layer on the modeling stage 22, onto the modeling stage 22. Then, as illustrated in FIG. 6A, the supply roller 13 moves along the Y axis direction while rotating. Thus, the powder P on the lifting plate 12 is extruded in the modeling box 21 and the supply roller 13 subsequently moves on the modeling stage 22 along the Y axis direction while rotating, thereby depositing the powder P for one flat layer on the modeling stage 22.

For such flattening of the powder P on the modeling stage 22, a roller, not shown, moving along the Y axis directions while rotating on the modeling stage 22 may also be provided separately from the supply roller 13.

As illustrated in FIG. 6B, while moving along the Y axis direction, the Y head 41Y selectively ejects the liquid to a region in accordance with the cross-sectional image data out of the entire modeling region 22a (refer to FIGS. 5A and 5B) just like printing by a normal printer. Thus, the powder P in the region to which the liquid is ejected is bonded to each other to be solidified.

As illustrated in FIG. 6C, same as the last time, the lifting plate 12 is lifted and also the modeling stage 22 is lowered for one layer of the powder P. Then, the powder P for one layer is supplied onto the modeling stage 22 (on the powder P of the first layer modeling processed earlier) by the supply roller 13.

As illustrated in FIG. 6D, while moving along the X axis direction, the X head 41X selectively ejects the liquid to a region in accordance with the cross-sectional image data out of the entire modeling region 22a just like printing by a normal printer. In such a manner, the liquid is supplied to the powder P of the second layer using the X head 41X.

To the powder P of a third layer supplied by the supply roller 13 next, the liquid is ejected again using the Y head 41Y. In such a manner, after that, the liquid is ejected alternately in a manner such as ejection from the X head 41X, ejection from the Y head 41Y, ejection from the X head 41X, and the like.

Then, after ejecting the liquid to the powder P of the last layer, as illustrated in FIG. 6E, a model T thus formed is taken out of the modeling box 21.

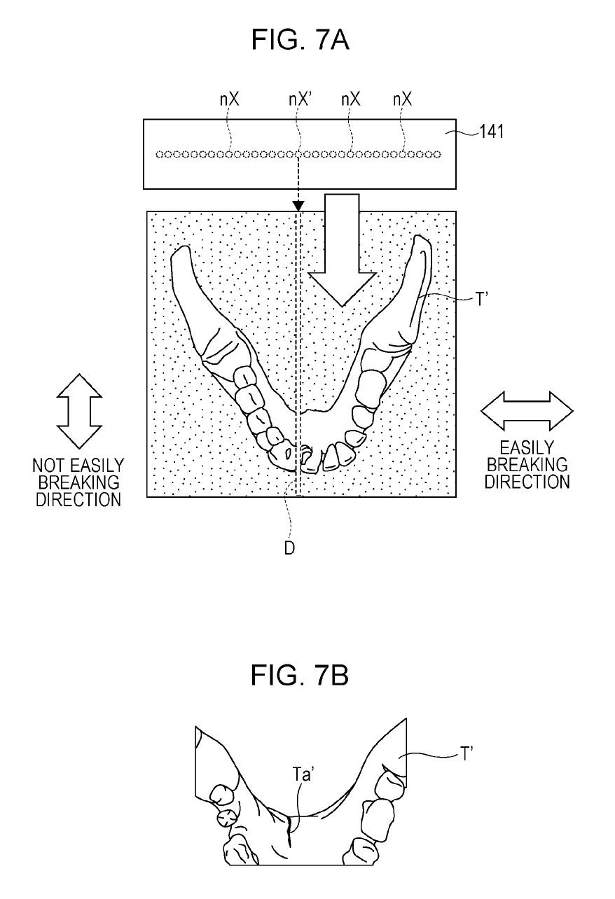

FIG. 7A is a plan view illustrating a modeling box 21 housing a model therein that is formed by a method subjected to comparison with the embodiment. In this example, a model T′ of a jawbone (including teeth) of a person as the modeling object is formed using one head in a line shape movable along the Y axis directions. As illustrated in FIG. 7A, in a case of occurring an ejection defect, such as clogging, in at least one nozzle nX′ out of the plurality of nozzles nX aligned in the X axis direction in a head 141, the liquid is not ejected appropriately on the line through which the nozzle nX′ passes. That way, a defect region D is formed that is a boundary region making the model T′ easily broken and isotropically focused in the Y axis direction. As such a defect region D is formed in the model T′, as illustrated in FIG. 7B, a defect Ta′ in the form of a thread split occurs in the model T′ thus formed.

Even when no ejection defect is developed, in a case that, for example, an amount of ejection from each nozzle nX varies, there also arises a problem such that the model T′ is easily broken in the X axis directions and not easily broken in the Y axis directions in FIG. 7A.

In contrast, according to the three-dimensional modeling device 100 of the embodiment, the X head 41X and the Y head 41Y eject the liquid alternately to the powder P for each one layer while moving along the directions orthogonal to each other. Accordingly, even if an ejection defect occurs in at least one of the plurality of nozzles nX and nY in the X head 41X and/or the Y head 41Y, or even if the amounts of ejection from the nozzles nX and nY vary, the defect region D or the variation becomes anisotropic. That is, it is possible to inhibit the formation of the defect region D continuously at a same position in the direction of laminating the powder P (in the Z axis direction) as illustrated in FIGS. 7A and 7B. Thus, the model T can be prevented from being damaged in easily breaking directions.

In the embodiment, the X head 41X and the Y head 41Y move orthogonally, so that in comparison to a case that they are not orthogonal, for example, the structure of the heads 41X and 41Y and the moving mechanisms 40X and 40Y can be simplified.

In the embodiment, the X head 41X and the Y head 41Y may also be used alternately for each plurality of layers not only alternately for each one layer.

### Another Embodiment

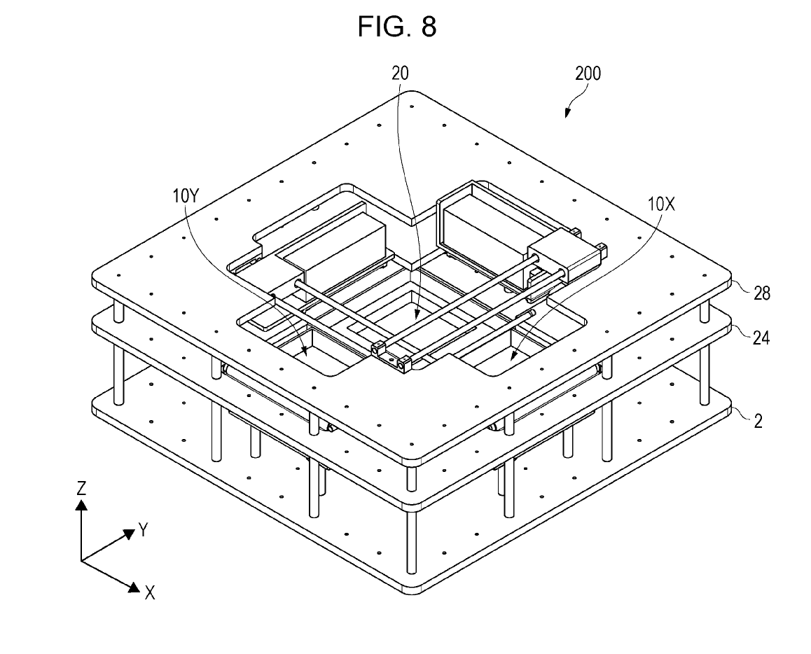

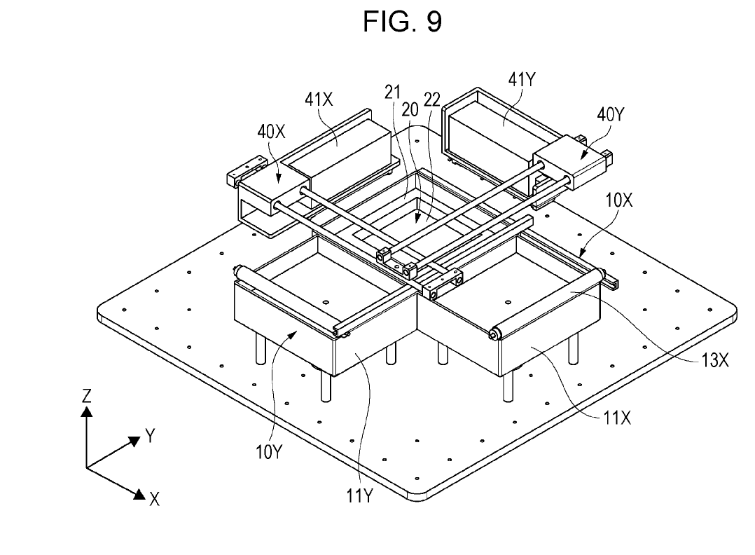

FIG. 8 is a perspective view illustrating a main portion of a three-dimensional modeling device according to another embodiment of the present disclosure. FIG. 9 is a perspective view illustrating a three-dimensional modeling device 200 illustrated in FIG. 8 in a state in which a top plate 28 and a printing base plate 24 are removed. In the description below, the description is simplified or omitted on the members and functions similar to those included in the three-dimensional modeling device 100 according to the previous embodiment and the description is mainly given to the different points.

The three-dimensional modeling device 200 according to the other embodiment is provided with two supply units 10X and 10Y. The basic structure and function of these supply units 10X and 10Y are respectively similar to the supply unit 10 according to the previous embodiment. In the other embodiment, in addition to the Y supply unit 10Y, the X supply unit 10X is added newly. As illustrated in FIG. 9, the X supply unit 10X is provided so as to be aligned with the modeling unit 20 in the X axis direction.

The X supply unit 10X has an X supply roller 13X movable in the X axis directions while rotating. To each of the supply units 10, different powders are supplied respectively. The different powders are classified due to, for example, the difference in the shape, the size, the material, or the like, or the difference in the properties, such as the magnetic property and the hardness.

In a case of the embodiment, typically the liquid is supplied by the X head 41X to the powder supplied by the X supply unit 10X, and the liquid is supplied by the Y head 41Y to the powder supplied by the Y supply unit 10Y. Alternatively, the liquid may also be supplied by the Y head 41Y to the powder supplied by the X supply unit 10X, and the liquid may also be supplied by the X head 41X to the powder supplied by the Y supply unit 10Y.

In the embodiment similar to the previous embodiment, the liquid is also ejected alternately using the X head 41X and the Y head 41Y for each one layer or for each plurality of layers.

As described above, in the embodiment, similar to the previous embodiment, it is possible to inhibit the formation of the defect region D isotropically and continuously in the layer direction. In addition, by the formation of a model with two different types of powders, it is possible to include regions having different materials and properties in one model.

In a case of the embodiment, different liquids may also be ejected from the X head 41X and the Y head 41Y. In that case, first powder including a binder, such as PVP, may also be supplied to the modeling box 21 from one supply unit of the two supply units 10X and 10Y, for example, and second powder, such as gypsum (powder not including a binder), may also be supplied to the modeling box 21 from the other one supply unit. Then, out of the two heads 41X and 41Y, one head may also eject a liquid not including a binder, such as a water soluble ink, to the first powder and the other one head may also eject a second liquid including a binder to the second powder.

In the embodiment, same powder may also be supplied from the X supply unit 10X and the Y supply unit 10Y. In this case, since the amount of powder housed respectively in the two supply boxes 11X and 11Y can be half in comparison to the case of one supply box 11, each thickness of the two supply boxes 11X and 11Y can also be half of that. Thus, it becomes possible to make the three-dimensional modeling device 200 thinner.

### Still Another Embodiment

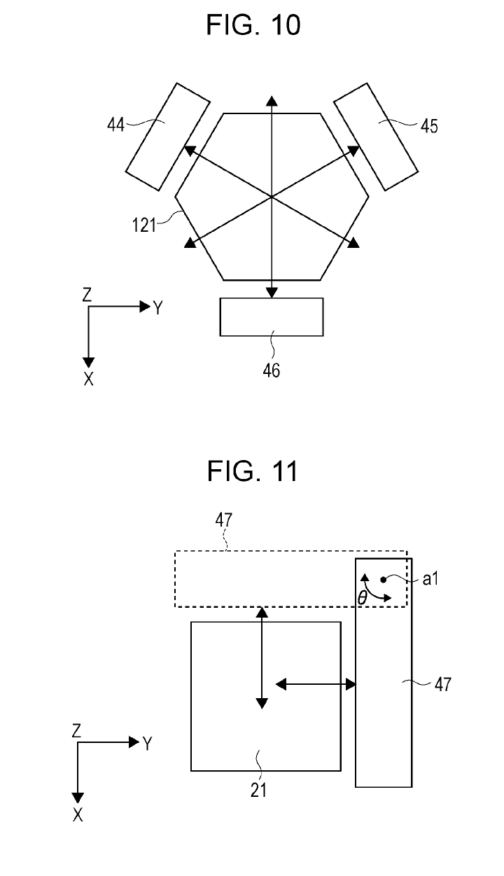

FIG. 10 illustrates a main portion of a three-dimensional modeling device according to still another embodiment of the present disclosure and is a plan view illustrating a modeling box and heads.

A modeling box 121 according to the embodiment has, for example, a hexagonal outline. At positions along three sides surrounding the modeling box 121, which are, for example, positions apart at a rotation angle of 120° from each other taking the Z axis as the center, heads 44, 45, and 46 to eject a liquid are disposed, respectively. These heads 44, 45, and 46 are respectively movable along the X-Y plane at a respective angle 120° different to each other by a moving mechanism not shown.

In such a manner, as the number of the heads increases, the moving mechanism becomes complex but it becomes possible to form a more highly anisotropic model.

The modeling box 121 is not limited to be hexagonal, and it may also be quadrangular as described above or may also be triangular or circular.

### Yet Another Embodiment

FIG. 11 illustrates a main portion of a three-dimensional modeling device according to yet another embodiment of the present disclosure and is a plan view illustrating a modeling box and a head.

A three-dimensional modeling device according to the embodiment has one head 47 to eject a liquid and is provided with a rotation mechanism to rotate the head 47 about the Z axis. For example, a rotation axis al of the rotation mechanism is provided in the vicinity of one end of the head 47. The head 47 is movable along the X axis and the Y axis directions by an X-Y moving mechanism, not shown. As the X-Y moving mechanism, a mechanism of an XY stage in the past may be used, for example.

In the three-dimensional modeling device thus composed, the rotation angle of the head 47 is changed by 90° for each one layer or each plurality of layers, and while moving alternately in the X axis directions and in the Y axis directions, respectively, it ejects the liquid to the powder in the modeling box 21.

### Other Embodiments

Embodiments according to the present disclosure are not limited to the embodiments described above, and can be other various embodiments.

In each of the embodiments above, a liquid is ejected by the heads alternately for each same number of layers of the powder. However, a liquid may also be ejected alternately by the heads for each different number of layers, or for a random number of layers. “For each different number of layers” means a pattern such that, for example, a liquid is ejected for each first number of layers (for example, for each one layer) by one head and for each second number of layers (for example, for each two or three layers), which is different from the first number of layers, by another head.

Alternatively, to powder for one layer, after one head ejects a liquid, another head may also eject a liquid to the same layer of the powder.

The embodiments described first and third show the modes of ejecting a same liquid from a plurality of heads. However, at least two out of these heads may also eject different liquids. For example, when the liquids are color inks, inks of different compositions, that is, of different colors may also be ejected.

In the three-dimensional modeling devices according to each of the above embodiments, one head is provided with a head of a line shape moving in one direction. However, at least one head out of the plurality of heads may also be a short head having, not a head of a line shape, a plurality of nozzles and having a length narrower than a modeling width in the modeling box 21. In this case, after ejecting a liquid in one line locally on the powder while moving the short head in a direction orthogonal to the direction of the nozzle alignment, the head is moved in the direction of nozzle alignment and the liquid is ejected in next one line locally on the powder. In this case, for each one head, a biaxial moving mechanism is provided to move the head.

In a case of using only one head of a line shape, it may also be used by shifting the position of the head by a predetermined distance (for example, distance of a plurality of nozzles) in the direction of the nozzle alignment for each one layer or for each plurality of layers of the powder. Thus, it is possible to avoid occurrence of a large number of continuous defect regions D along the direction of laminating the powder.

A heater for heat treatment of the formed model may also be provided in each three-dimensional modeling device described above.

A cleaning mechanism to clean a plurality of heads may also be provided in each three-dimensional modeling device described above. In this case, while a liquid is ejected by a first head, a second head is cleaned by the cleaning mechanism and thus the time efficiency can be improved. The cleaning mechanism may be mechanical cleaning using a brush or a wiper, chemical cleaning using a cleaning fluid, or a combination of them.

In the above embodiments, a moving mechanism is provided to move a plurality of heads. However, the plurality of heads may also be fixed and each of the three-dimensional modeling devices may also be provided with a moving mechanism to move a modeling box (modeling stage).

The present disclosure contains subject matter related to that disclosed in Japanese Priority Patent Application JP 2010-284440 filed in the Japan Patent Office on Dec. 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional modeling device, comprising:
a stage having a powder material deposited thereon for lamination;
a supply mechanism supplying the powder material for each one layer on the stage;
a plurality of heads having a plurality of nozzles ejecting a liquid for formation of a model, respectively, and capable of ejecting the liquid to the powder material supplied onto the stage by the supply mechanism; and
a moving mechanism moving the plurality of heads in different directions relative to the stage, respectively.

2. The three-dimensional modeling device according to claim 1, wherein
the moving mechanism moves two heads, which are the plurality of heads, to make moving directions of the two heads to be orthogonal.

3. The three-dimensional modeling device according to claim 1, wherein
the moving mechanism alternately moves the plurality of heads every time the powder material for one layer is supplied by the supply mechanism.

4. The three-dimensional modeling device according to claim 1, wherein
the moving mechanism moves a first head out of the plurality of heads when the powder material for a continuous first number of layers is supplied by the supply mechanism, and moves a second head, different from the first head, out of the plurality of heads when the powder material for a continuous second number of layers is supplied by the supply mechanism.

5. The three-dimensional modeling device according to claim 4, wherein
the first number of layers is different from the second number of layers.

6. The three-dimensional modeling device according to claim 1, wherein
the supply mechanism supplies a plurality of different powder materials corresponding to the plurality of heads, respectively, to the stage.

7. The three-dimensional modeling device according to claim 1, wherein
the plurality of heads ejects different liquids, respectively.

8. A three-dimensional modeling device, comprising:
a stage having a powder material deposited thereon for lamination;
a supply mechanism supplying the powder material for each one layer on the stage;
a head having a plurality of nozzles ejecting a liquid for formation of a model and capable of ejecting the liquid to the powder material supplied onto the stage by the supply mechanism; and
a moving mechanism moving the head in respective different directions relative to the stage when the liquid is ejected respectively to the powder material for different layers supplied by the supply mechanism.

9. The three-dimensional modeling device according to claim 8, further comprising:
a rotation mechanism rotating the head about an axis along a direction of laminating the powder material.

10. A three-dimensional modeling method, comprising:
supplying a powder material for one layer onto a stage;
ejecting a liquid for formation of a model, while moving a first head in a first direction relative to the stage, from the first head to the powder material supplied onto the stage;
supplying the powder material for another layer onto the stage after ejecting the liquid from the first head; and
ejecting a liquid for formation of a model, while moving a second head in a second direction, different from the first direction, relative to the stage, from the second head to the powder material supplied onto the stage.

11. A model formed by a three-dimensional modeling method, comprising:
supplying a powder material for one layer onto a stage;
ejecting a liquid for formation of a model, while moving a first head in a first direction relative to the stage, from the first head to the powder material supplied onto the stage;
supplying the powder material for another layer onto the stage after ejecting the liquid from the first head; and
ejecting a liquid for formation of a model, while moving a second head in a second direction, different from the first direction, relative to the stage, from the second head to the powder material supplied onto the stage.
